(19) United States
(12) Patent Application Publication
(10) Pub. No.: US 2008/0009159 A1
(43) Pub. Date: Jan. 10, 2008

(54) Dustproof structure for an electronic apparatus

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/643,849

(22) Filed: Dec. 22, 2006

(30) Foreign Application Priority Data
Jul. 4, 2006 (TW) 95211760

(51) Int. Cl. H01R 13/44

(52) U.S. Cl. 439/138

(57) ABSTRACT

A dustproof structure for an electronic apparatus includes an insulating body, and a dustproof cover. On one side of the insulating body, there is at least one card-plugging space, and there is an arc track located on one side of the insulating body and extending to the opening of the card-plugging space. The dustproof cover covers the opening of the card-plugging space, and the side wall of the dustproof cover corresponds to the arc track. When the card-plugging space is not in use, the user pushes the dustproof cover to make the dustproof cover slide to the opening of the card-plugging space from the receiving space along the arc tracks. Therefore, the card-plugging space is sealed, and dustproof structure prevents the electronic apparatus from accumulating dust or being invaded by small bugs.

### BACKGROUND OF THE INVENTION

1. Field of the Invention

The present invention relates to a dustproof structure for an electronic apparatus. In particular, this invention relates to a dustproof structure for an electronic apparatus in which the dustproof cover is installed in the insulating body. The structure is simple, the required space is small, and the dustproof effect for the electronic apparatus is perfect.

2. Description of the Related Art

Electronic apparatuses with electronic cards are found in many modern day devices, such as card reading machines, cell phones, electronic dictionaries, digital still cameras, PDAs, MP3, and laptops, etc. The structure of the electronic card is simplified so that the dimensions of the electronic card are small. Therefore, the electronic apparatus having an electronic card can be small and light enough to be carried around conveniently.

In these electronic apparatuses there is a space for a card to be plugged into the electronic apparatus. The electronic apparatus accesses the data stored on the electronic card. However, when the card-plugging space of the prior art is not in use or is plugged with an electronic card, the opened card-plugging space accumulates dust easily, or can be invaded by small bugs. This negatively affects the contact between the electronic card and the card-plugging space.

In order to overcome the above problem, a dustproof structure for an electronic apparatus has been developed. For example, a rubber plug, a drawer-typed cover, a rotating-shaft cover, or a spring cover can be installed on the outside of the card-plugging space. When the card-plugging space is not in use, the dustproof prevents the card-plugging space from accumulating dust or being invaded by small bugs. The contacting quality is thereby assured.

However, the dustproof structure for an electronic apparatus of the prior art has some drawbacks:

1. When the dustproof structure for an electronic apparatus is a rotating-shaft cover or a spring cover, a rotating-shaft or a spring is required to open or close the cover. The structure is complex, the assembling process is difficult, the manufacturing cost is high, and it is easily damaged.

2. When the dustproof structure for an electronic apparatus is a rubber plug, a drawer-typed cover, the rubber plug or the drawer-typed cover must be pulled out from the electronic apparatus when the electronic card is plugged into the card-plugging space. Both occupy space, and it is inconvenient for the user. Especially, when the rubber plug is taken out from the card-plugging space, the user easily loses it. The card-plugging space can accumulate dust or be invaded by. The contacting quality thereby becomes worse.

### SUMMARY OF THE INVENTION

One particular aspect of the present invention is to provide a dustproof structure for an electronic apparatus. It prevents the electronic apparatus from accumulating dust or being invaded by small bugs. Its structure is simple, the manufacturing cost is reduced, and no redundant space is occupied. The goal of being light and small and convenient for the user to carry around is achieved.

The dustproof structure for an electronic apparatus includes an insulating body, and a dustproof cover. On one side of the insulating body, there is at least one card-plugging space, and there is an arc track located on one side of the insulating body and extending to the opening of the card-plugging space. The dustproof cover covers the opening of the card-plugging space, and the side wall of the dustproof cover corresponds to the arc track.

When the card-plugging space is not in use, the user pushes the dustproof cover to make the dustproof cover slide to the opening of the card-plugging space from the receiving space along the arc track. Therefore, the card-plugging space is sealed, and the dustproof structure prevents the electronic apparatus from accumulating dust or being invaded by small bugs.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is an assembly perspective view of the present invention;

FIG. 2 is an exploded perspective view of the present invention;

FIG. 3 is a perspective view of the first embodiment of the present invention;

FIG. 4 is a schematic diagram of the operation of the first embodiment of the present invention; and

FIG. 5 is a schematic diagram of another operation of the first embodiment of the present invention.

### DETAILED DESCRIPTION OF THE PREFERRED EMBODIMENTS

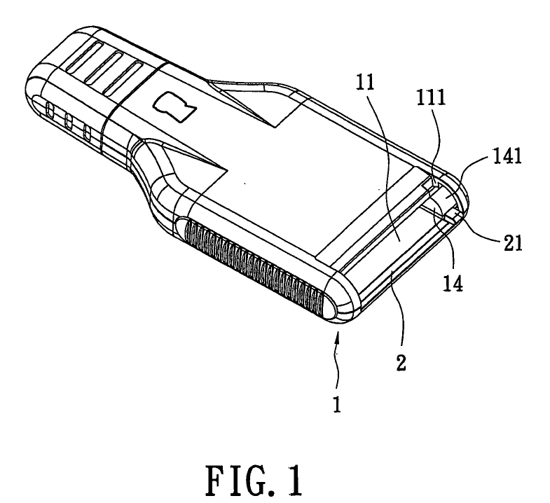

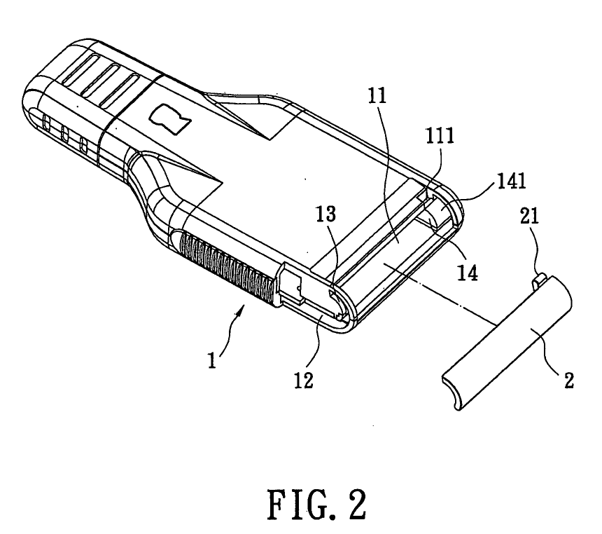

Reference is made to FIGS. 1 and 2. The dustproof structure for an electronic apparatus includes an insulating body 1, and a dustproof cover 2.

On one side of the insulating body 1, there is at least one card-plugging space 11, and there is a receiving space 12 located on the side of the insulating body 1. The card-plugging space 11 and the receiving space 12 are individually located on the upper side and lower side of the insulating body 1. At both sides of the insulating body 1, there is an arc track 13 extending upward from the side wall of receiving space 12 to the side wall of the opening of the card-plugging space 11. A guiding block 14 located on the inner side of the card-plugging space 11 of the insulating body 1. A guiding surface 141 is formed on the guiding block 14 for guiding the dustproof cover 2 to slide along the arc track 13. There is a positioning wedged groove 111 located on one side of the card-plugging space 11 of the insulating body 1.

The dustproof cover 2 has an arc shape and covers the opening of the card-plugging space 11. The side wall of the dustproof cover 2 corresponds to the arc track 13. There is a guiding-pulling block 21 on the dustproof cover 2. When the dustproof cover 2 moves to the end of its stroke, the guiding-pulling block 21 is wedged into the positioning wedged groove 111.

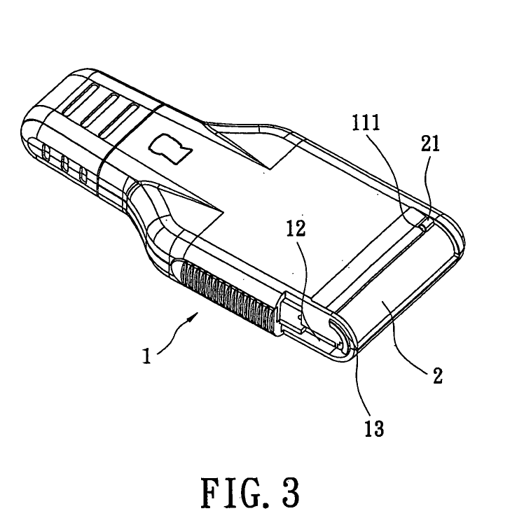

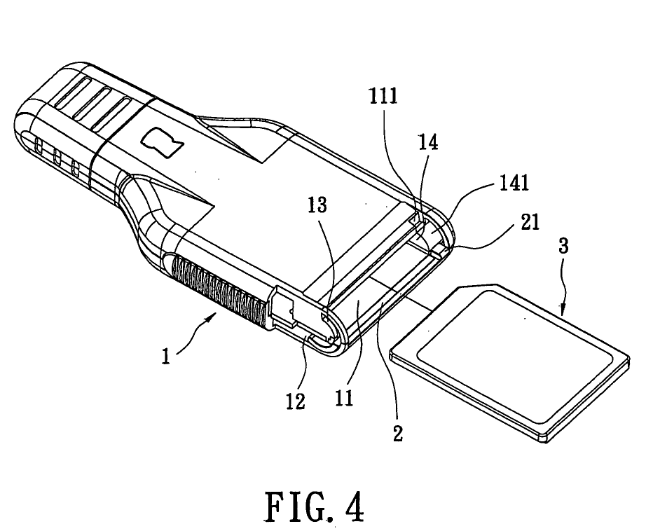

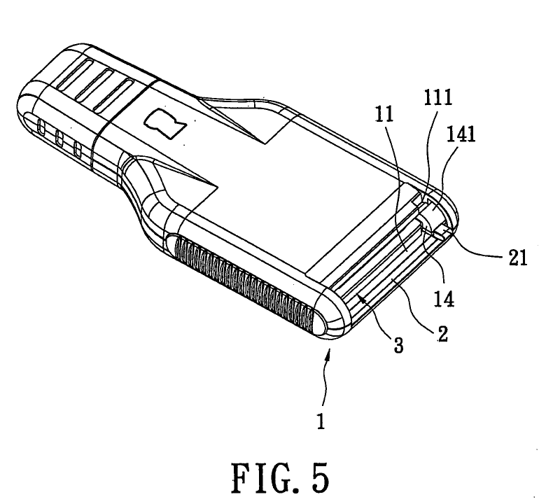

Reference is made to FIGS. 1, 3, 4 and 5. When the card-plugging space 11 is not in use or is plugged with an electronic card 3, the user pushes the guiding-pulling block 21 of the dustproof cover 2 to make the pulling block 21 synchronously rotate with the cover shaft. Therefore, the dustproof cover 2 slides to the opening of the card-plugging space 11 from the receiving space 13 along the arc tracks 13 until the card-plugging space 11 is sealed and the guiding-pulling block 21 is wedged into the positioning wedged groove 111. Thereby, the dustproof structure prevents the electronic apparatus from accumulating dust or being invaded by small bugs. When the user wants to take out or replace the electronic card 3 in the card-plugging space 11, the user inversely pushes the guiding-pulling block 21 of the dustproof cover 2 to remove the dustproof cover 2 fully out from the card-plugging space 11 so that it is stored in the receiving space 12. The card-plugging space 11 is open and the electronic card 3 can be plugged into the card-plugging space 11.

The present invention has the following characteristics:

1. The present invention includes the arc track 13 in the insulating body 1 that controls the dustproof cover 2 to slide so as to open and close the card-plugging space 11. There is no complex structure, such as a rotating shaft or a spring. The assembling process is easy, the manufacturing cost is reduced, and it is not easily damaged.

2. When the card-plugging space 11 is plugged with the electronic card 3, the dustproof 2 moves along the arc track 13 and is stored in the receiving space 12. No space is required. The goal of being light and small and convenient for a user to carry around is achieved.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A dustproof structure for an electronic apparatus, comprising:
an insulating body, wherein on one side of the insulating body, there is at least one card-plugging space, and there is an arc track located on one side of the insulating body and extending to an opening of the card-plugging space; and
a dustproof cover covered on the opening of the card-plugging space, wherein one side wall of the dustproof cover corresponds to the arc track.

2. The dustproof structure for an electronic apparatus as claimed in claim 1, wherein the insulating body has a receiving space.

3. The dustproof structure for an electronic apparatus as claimed in claim 2, wherein the card-plugging space and the receiving space are individually located on the upper side and lower side of the insulating body.

4. The dustproof structure for an electronic apparatus as claimed in claim 3, wherein the arc track is located on a side wall of the receiving space and extends to a side wall of the opening of the card-plugging space.

5. The dustproof structure for an electronic apparatus as claimed in claim 1, wherein a guiding block is located on an inner side of the card-plugging space of the insulating body for guiding the dustproof cover to slide along the arc track.

6. The dustproof structure for an electronic apparatus as claimed in claim 5, wherein a guiding surface is formed on the guiding block.

7. The dustproof structure for an electronic apparatus as claimed in claim 1, wherein the dustproof cover has a guiding-pulling block.

8. The dustproof structure for an electronic apparatus as claimed in claim 7, wherein there is a positioning wedged groove located on one side of the card-plugging space of the insulating body, and the positioning wedged groove is located on the end of the stroke of the guiding-pulling block and corresponds to the guiding-pulling block.

9. The dustproof structure for an electronic apparatus as claimed in claim 1, wherein the dustproof cover is arc-shaped.

10. The dustproof structure for an electronic apparatus as claimed in claim 1, wherein there are two arc tracks that are individually located on both sides of the insulating body extending to two sides of the opening of the card-plugging space.
